(19) United States
(12) Patent Application Publication
(10) Pub. No.: US 2008/0165669 A1
(43) Pub. Date: Jul. 10, 2008

(54) Read-side anti-theft optical discs and method of manufacturing read-side anti-theft optical discs

(75) Inventors: Anthony C. New, Terre Haute, IN (US); Richard Selinfreund, Terre Haute, IN (US); Brian D. Dieckman, Terre Haute, IN (US)

Correspondence Address: RADER FISHMAN & GRAUER PLLC, LION BUILDING, 1233 20TH STREET N.W., SUITE 501, WASHINGTON, DC, 20036, US

(73) Assignees: Sony Corporation, Tokyo (JP); Sony DADC US Inc., Terre Haute, IN (US)

(21) Appl. No.: 12/003,427

(22) Filed: Dec. 26, 2007

Related U.S. Application Data
(60) Provisional application No. 60/878,888, filed on Jan. 5, 2007.

(51) Int. Cl. G11B 7/24

(52) U.S. Cl. 369/275.5

(57) ABSTRACT

The invention relates to methods for manufacturing an optical devices and optical devices incorporating optical blocking material on the read-side surface of the optical disc. A protective layer and an optical blocking material are applied to the read-side surface of an optical disc. The protective layer, for example, may prevent corrosive solvents in the optical blocking material from damaging the read-side surface of the optical disc. Applying the optical blocking material to the read-side surface of the optical disc may prevents an optical disc player from reading the optical device until the optical blocking material deactivated. Once activated, the optical blocking material becomes sufficiently transparent to allow the optical disc player to read the optical disc.

### CROSS REFERENCE TO RELATED APPLICATIONS

This application claims the benefit of U.S. provisional application Ser. No. 60/878,888, titled “Methods to manufacture read-side anti-theft optical discs” and filed on Jan. 5, 2007, the entire contents of which are hereby incorporated by reference.

### BACKGROUND OF THE INVENTION

1. Field of the Invention

The present invention relates generally to methods of manufacturing optical devices, and in particular, to methods of manufacturing optical devices having protective coatings and including optical blocking materials.

2. Description of the Related Art

For the purposes of the present discussion, an optical device may be any device or medium that relies on optics to function properly. Examples of optical devices include, but are not limited to, Compact Discs (CDs), Digital Video Discs (DVDs), High Density DVDs (HD-DVDs), Blu-ray discs, and so on.

Systems and methods for selectively activating products are employed in various demanding applications including product theft-prevention, rental-return enforcement, and prevention of copyright infringement. Such applications often demand cost-effective systems that are difficult to circumvent, yet convenient to control with the appropriate equipment.

Systems for selectively activating products are particularly important in theft-prevention applications involving readily shoplifted optical devices, such as CDs and DVDs. Conventionally, such optical devices are tagged with a theft-prevention device, such as a sticker or a Radio Frequency Identification Tag (RFID) that is deactivated upon purchase. When deactivated, the devices prevent alarm-triggering tag functions from triggering alarms when a customer exits a merchandise outlet, such as a retail store.

Unfortunately, thieves often readily notice and remove such tags, or alternatively circumvent such safe guards by simply removing the media from its casing. Furthermore, RFID tags may undesirably increase product costs and may further emit undesirable radio frequencies even after activation.

One class of product activation technologies includes lacquer or film-based optical blocking materials, which are applied onto optical-based products, such as optical discs, to inhibit product functionality. Application of these products generally includes the application of a dye coating onto the read/write surface of the optical products, to obscure the contents of the optical product from the reader. These antitheft materials are commonly reactive to certain forms of radiation, such as ultraviolet (UV) light, which are used to activate the dye coating as part of the checkout process, when a consumer purchases the product.

The optical blocking materials are applied to the readable surface of the optical device during production. Thereafter, a sufficient energy is applied to the optical blocking material to activate the optical blocking materials, and thereby transition the optical blocking material from a non-transparent to a transparent condition. Once the device has been activated, an appropriate optical disc player (e.g., a CD player, DVD player, Blu-Ray disc player, etc.) may read the device.

Conventionally, optical blocking materials are applied before a protective layer, or mixed into the protective layer. This combination of energy sensitive materials (i.e., the optical blocking materials and protective layer) during production requires the careful application of radiation during the material curing process, to prevent activating the optical device during manufacture. However, this technique is slow and may be cost prohibitive.

Furthermore, conventional techniques for applying optical blocking materials suffer from certain manufacturing drawbacks. For example, the conventional technique for applying the antitheft material involves the application of the material to the entire surface of the optical disc using a spin-coat process. The first drawback of this technique is the cost incurred by coating the entire disk. A second drawback is the time necessary to ensure that, upon checkout, the entire optical device is activated and the entire read/write surface is readable by a player. Therefore, it may be necessary to remove and inspect the optical device after activation to ensure that the entire optical surface is activated. Alternatively, it may be necessary to expose the optical device to radiation for a prolonged period, and/or make the entire optical surface visible within the packaging to allow for proper inspection.

Another conventional technique is to apply the antitheft material to the entire optical surface and use a masking technique to activate all the optical blocking material on the disc, except the portion over the lead-in region. This technique allows for a shorter more targeted application of activating radiation to the optical surface at the point of sale. However, this technique also suffers from the expense associated with covering the entire read/write surface of the optical device with the optical blocking material and requires a more costly and complex manufacturing process.

### SUMMARY OF THE INVENTION

The present invention accommodates selectively enabling or disabling an optical device, such as an optical disc.

An embodiment includes a method of manufacturing an optical device including applying a protective layer and an optical blocking material over a read-side surface of an optical disc. The protective layer, for example, may prevent corrosive solvents in the optical blocking material from damaging the read-side surface of the optical disc. Applying the optical blocking material to the read-side surface of the optical disc may prevent an optical disc player from reading the optical device until the optical blocking material is in an inactivated. For example, the optical blocking material may cause an optical disc player from reading the optical disc by the player to experience symmetry-reading errors. Once activated, the optical blocking material may become sufficiently transparent to allow the optical disc player to read the optical disc.

Another embodiment of the present invention includes an optical device, such as an optical disc, having a protective layer covering at least a portion of a readable area of the read-side surface and an optical blocking material covering at least a portion of the read-side surface. The protective layer may include a material that prevents corrosive solvents in the optical blocking material from damaging the read-side surface of the optical device.

The optical blocking material may be printed in any pattern that makes the optical disc unreadable by an optical disc player, while the optical blocking material is inactive. The optical blocking material may be printed onto the read-side of the optical disc in the various shapes and configuration. For example the optical block material may cover the entire read-side surface of the optical disc. Alternatively, all or a portion of the lead-in of the optical disc may be covered by the optical blocking material. Furthermore, the optical blocking material may be applied in radial patterns, for example, a repeating diamond edge or a serrated edge pattern.

The optical blocking material may be printed onto the read-side of the optical disc using various techniques including, for example, a spin-coating, ink-jet printing or pad-transfer mechanisms.

The specific embodiments described herein may be employed to enable optical devices at the time of purchase using time and energy levels that are acceptable in a retail setting. The present invention provides a cost-effective solution to inhibiting theft of optical devices that meets customer requirements for speed and effectiveness.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, with reference to the accompanying drawings, in which:

FIG. 1 illustrates a conventional optical disc with a conventional optical read system.

FIG. 2 illustrates the optical disc coated with a protective layer and an optical blocking material.

FIGS. 3A-3E are cross sectional views of the steps of a manufacturing process for producing optical devices in accordance with the exemplary embodiment.

FIG. 4 illustrates the activation of an exemplary embodiment of an optical device.

FIG. 5 illustrates a cross section of the activation of an exemplary embodiment of a optical device.

FIG. 6 illustrates an exemplary embodiment of an optical device after activation.

FIG. 7 is a flow chart of the process used for manufacturing and enabling optical devices equipped with the theft prevention system of the present invention.

FIG. 8A illustrates a second exemplary embodiment of an optical device showing a serrated edge printed pattern.

FIG. 8B illustrates a second exemplary embodiment of an optical device showing a diamond edge printed pattern.

FIG. 9 illustrates a flow chart of a pad transfer printing method for applying an optical blocking material.

FIG. 10 illustrates a flow chart of an inkjet printing method for applying optical blocking material.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

An optical device may be any device or medium that employs optical energy to function as desired. An optical device may include any optical disc employed to store, provide, and/or manipulate data using selective application of optical energy. An optical disc may employ a beam of optical energy for reading and/or writing data to/from the optical disc. Examples of optical discs include, but are not limited to, Digital Video Discs (DVDs), Compact Discs (CDs), CD Recordable (CDR) media, CD Read/Write (CDRW) media, Blu-Ray discs, High-Density (HD) discs, optical memory cards, credit cards, Subscriber Identity Module (SIM) cards, and so on.

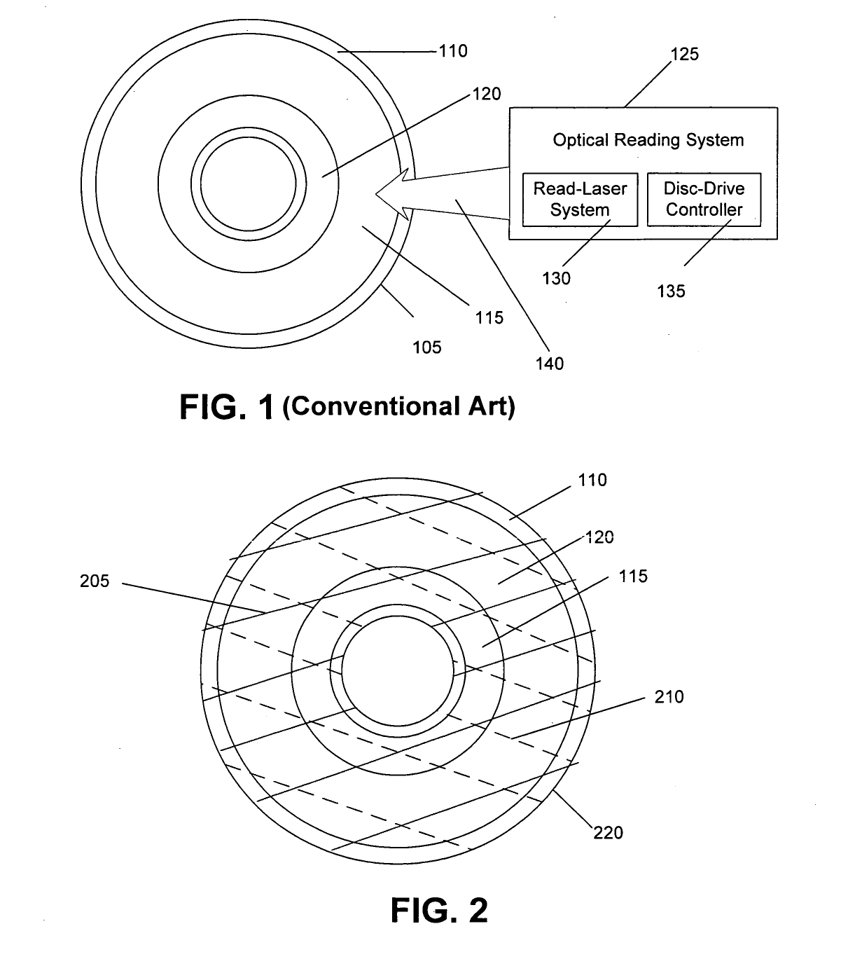

FIG. 1 illustrates a read-side of a conventional optical device 105, such as an optical disc. The read-side surface of optical device 105 includes a spiral track, which is strategically pitted to encode information that is readable by an optical read system 125. The optical read system 125 includes a read-laser system 130 in communication with a disc-drive controller 135. The drive controller 135 may include a control algorithm and an accompanying actuator for controlling the read-laser system 130. The read-laser system 130 may include one or more optical pickups, Digital-to-Analog Converters (DACs), amplifiers, and so on.

The read-laser system 130 produces a laser beam 140, which reflects off of patterned pits included in the spiral track on the read-side surface of optical device 105. The pattern of reflected light may be employed by the optical read system 125 or an accompanying computer to decode information encoded on the read-side surface of optical device 105 via the pits.

The conventional read-side surface of the optical device 105 shown in FIG. 1 has a lead-in area 120 containing the table of contents for the optical device 105, a program area 115 containing individual tracks with blocks of data, and a lead-out area 110. The lead-in area 120 must be accessible to enable functional play. If the lead-in area 120 is not visible or is corrupted, the optical device 105 becomes unplayable. Unplayability can also be accomplished by blocking access to a particular file system boot area on the read-side surface of the optical device 105, such as any of the file system's volume descriptors. These volume descriptors typically reside near the beginning of the volume space. For example, in the case of DVD discs, the descriptors may be located from sector numbers 0 through 256. Also, blocking access to any path tables, directory records and file descriptors located after or near this same area can make the discs unplayable.

FIG. 2 illustrates a first exemplary embodiment of a read-side of an optical device 220 including a protective coat 205 and an optical blocking material 210. The optical blocking material 210 selectively enables and disables optical device 220. The optical blocking material 210 is applied over a protective layer 205, to an entire read-side surface of the optical device 220 using a spin coating process or other suitable technique.

The optical blocking material 210 may be a photosensitive ink or dye and may change color or transparency in response to specific energy. For example, optical blocking material 210 may change in color or transparency in response to optical energy, vibration energy, or acoustic energy. Optical energy may be any energy within a portion of the electromagnetic spectrum between and including ultraviolet and radio frequencies.

As used in the present application, the terms “non-transparent” and “transparent” are used to describe the relative transmissive properties of the optical blocking material 210 in its inactivated and activated states, respectively. The term “non-transparent” refers to any condition of the optical blocking material 210 that prevents the optical device from being read or written to by an optical read system 125, even if such condition has some limited transparency (i.e., less transparency than the activated condition of the optical blocking material, but not completely opaque). The term “non-transparent” also includes a condition of the optical blocking material 210 being partially reflective or exhibiting a specific color that prevents the optical read system 125 from reading the optical device 220. The term “transparent” refers to the optical blocking material 210 being sufficiently transparent or non-reflective to enable the read system 220 to read the optical device 125.

The optical blocking material 210 can comprise various types of organic inks. The preferred coating chemistry contains a material that only dissolves in organic solvents. For example, optical blocking material 210 may include printing inks, such as those used in video jet printing (a version of continuous injection printing) without departing from the scope of the present invention. Specifically, example solvents may include methylethylkeytone, glycol ether, or ethyl acetate based ink. These inks provide the benefit of being used in common printing techniques and allow for the mixing of polymers into the solvent with makes for one-coat permanent, irremovable inks. Furthermore, organic solvents are the solvents most commonly used in connection with pad printing and inkjet printing processes, discussed in conjunction with the second and third embodiments below. Other suitable inks include any ink that may be dissolved in organic solvents, can be index matched to the optical material, such as polycarbonate, PMMA, Noryl PPO Resin, etc., and are not removable by household solvents (which are generally aqueous solvents).

Protective layer 205 provides a chemical barrier between the read-side surface of optical device 220 and optical blocking material 210. For example, it may be necessary to protect a polycarbonate layer 320 from direct exposure to the organic dye or ink of the optical blocking material 210 because of the corrosive effects organic dyes have on optical disc materials, such as polycarbonate. The protective coat 205 may comprise polymethyl methacrylate (PMMA), or similar plastic materials. For example, protective layer 205 may be a hardcoat, or similar material, without departing from the scope of the present invention.

Protective layer 205 may be applied in a thin layer, at high-speed, and at a low-cost. For example, protective layer 205 may be applied in a layer having a thickness in the range of 3 microns or less. Protective layer 205 may, preferably, have a cure cycle of 2 seconds or less, including the use of ultra violet radiation. Finally, the materials comprising the protective layer 205 may be cost effective, costing less than 0.2 cents per optical device.

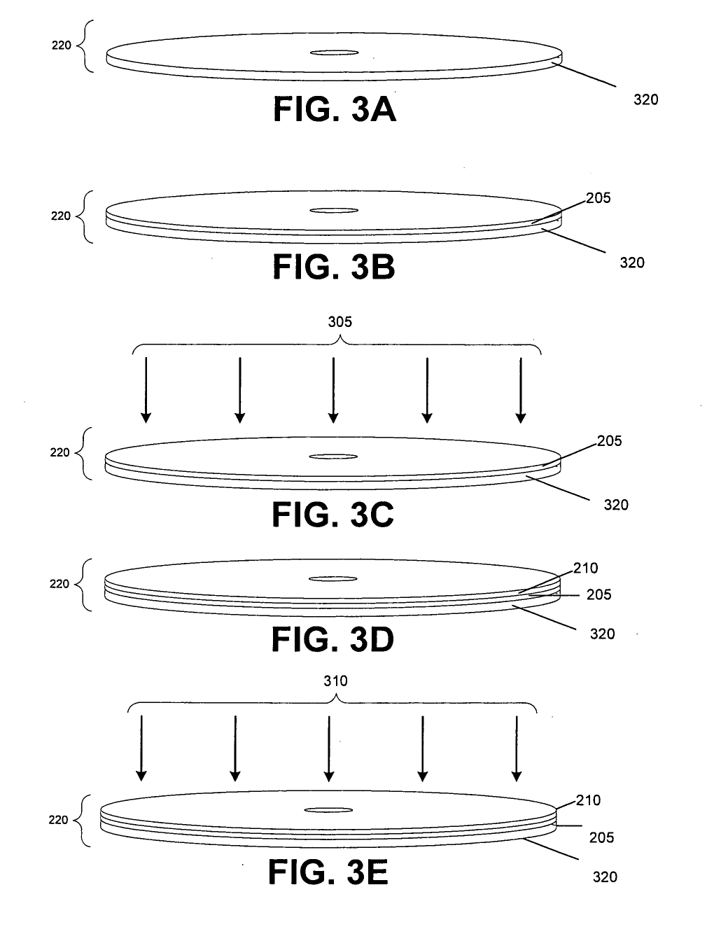

FIGS. 3A-3E comprise a cross sectional view of the optical device 220 during the manufacturing process for producing optical devices 220 in accordance with the first exemplary embodiment.

FIG. 3A illustrates an optical device 220, comprised of a polycarbonate disc 320, prior to the application of either the protective coat 205 and the optical blocking material 210. As discussed above, the optical device is not limited to a polycarbonate disc 320, but may also be formed of any appropriate material that passes light in the wavelength of 250-780 nm.

FIG. 3B illustrates an exemplary embodiment of an optical device 220 after a first spin-coating step. The first spin coating process may apply protective layer 205 to the read/write surface, through which light must pass to enable effective operation of the optical device 220. The protective layer 205 is applied in thick enough layers and/or in sufficient concentrations to protect the surface of the optical device 220 from corrosive and/or physical damage including that which may be imposed by application of inks containing organic solvents upon the read-side surface of the optical device 220.

During the spin-coating process, the optical device 220 rotates at a high speed, to spread the protective layer material by centrifugal force. Rotation continues while the excess material and fluid spins off the edges of the substrate, until the protective layer 205 attains the desired thickness. The thickness of the protective layer 205 may be controlled by changing the rotation speed, rotation duration, and/or concentration of the solution and solvent. Current spin-coating equipment used in the manufacture of optical devices 220 can be used to apply the protective layer 205.

FIG. 3C illustrates an exemplary application of a first energy 305 to the read/write surface of optical device 220. Once the protective layer 205 is applied to the optical device 220 by spin coating or a similar process, a sufficient first energy 305 is applied to the surface of the optical device 220, thereby curing the protective layer 205. The specific radiation 305 used to cure the protective layer 205 depends on the material comprising the protective layer 205. For example, the radiation may include one or a combination of ultraviolet lights, infrared energy, ultrasonic energy, or vibrational energy depending on the different types of protective layer material compositions.

FIG. 3D illustrates an exemplary embodiment of an optical device 220 after a second spin-coating application step. The second spin coating process applies the optical blocking material 210 using a similar process as for the first spin coating. The optical blocking material 210 may be combined with an organic solvent, and sprayed or poured onto the surface of the disc substrate, over the cured protective layer 205. Next, optical device 220 is spun at a high speed to spread the optical blocking material 210 using centrifugal force. The rotation continues while the excess material and fluid spins off the edges of the substrate, until the desired thickness of the optical blocking material 210 is achieved on the surface of the optical device 220. The thickness ofthe optical blocking material 210 may be controlled by adjusting the rotation speed, rotation duration, and/or concentration of the solution and solvent. Current spin-coating equipment used in the manufacture of optical discs can be used to apply the optical blocking material 210. The second and third embodiments, discussed below, illustrate further techniques for applying optical blocking material 210 to the readable surface of the optical device 220.

FIG. 3E illustrates the step of curing after the second spin-coating step illustrated in FIG. 3D. Once the optical blocking material 210 is applied to the optical device 220, a sufficient second radiation 310 is applied to the surface of the optical device 220 to cure, but not activate, optical blocking material 210. The specific level of radiation used to activate the optical blocking material 210, i.e. the level of radiation that may cause optical blocking material 210 to become transparent, can be selected based on the particular type of optical blocking material 210 used. For example, ultraviolet light, infrared energy, ultrasonic energy, or vibrational energy can be used for certain types of optical blocking material 210.

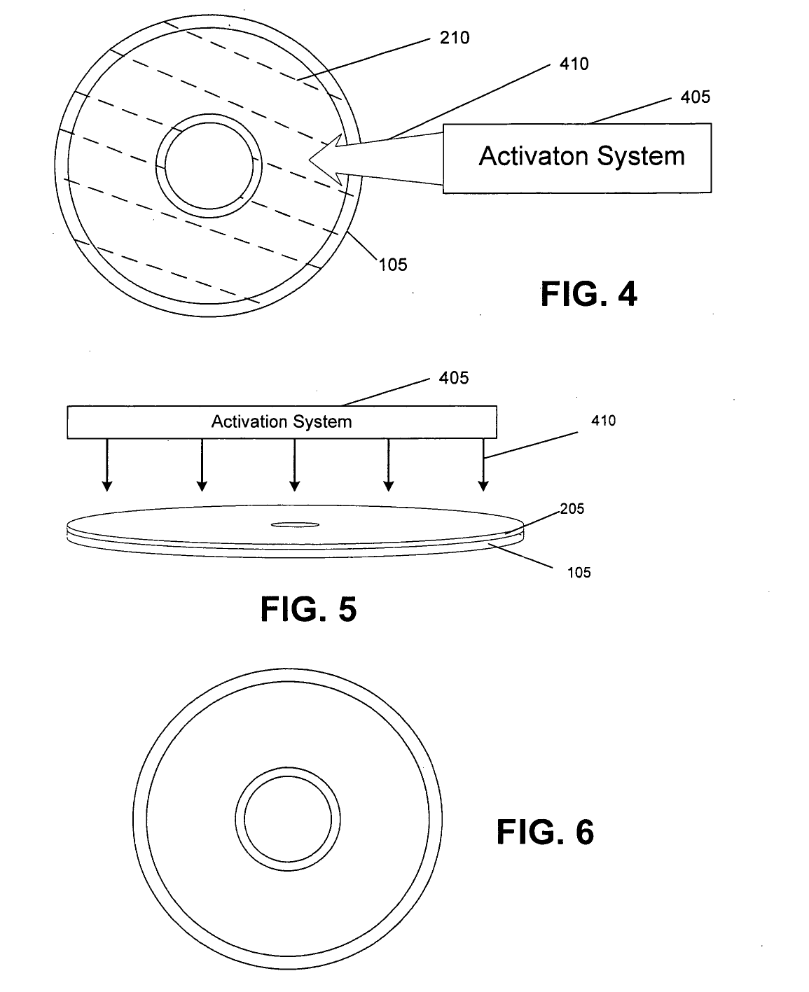

FIG. 4 and FIG. 5 illustrate the activation of an exemplary embodiment of an optical device 220 at a point of sale. For simplicity, only the relevant elements have been illustrated including the optical device 220, optical blocking material 210, Activation System 405, and activation energy 410.

The Activation System 405 is generally located at a retail store or supply chain location. The Activation System 405 applies an activation energy 410 to the optical blocking material 210 on the optical device 220 to activate the optical device 220. The activating energy 410 applied by the Activation System 405 is selected according to the type of optical blocking material 210 used, and may be similar to the type of energy used during the production process (e.g., ultraviolet, infrared, ultrasonic, vibration, etc.). The optical blocking material 210 can be formulated to require a certain wavelength and/or intensity of light or other type of energy to change its transparency. The exact activation energy 410 required for activation may be difficult for an unauthorized user or thief to determine.

In practice, the Activation System 405 at the retail or supply chain location will employ an activating energy 410 to selectively change the transparency of the optical blocking material 210, as needed. A user, such as a retail store clerk or other supply chain employee, may control the Activation System 405 at the time of purchase or movement through the supply chain. Alternatively, the Activation System 405 can be automatically controlled at the desired location, or controlled by another device, such as a cash register, in response to payment for the optical device 220 at the retail location.

Infrared and/or ultrasound equipment sufficient to activate an optical blocking material 210, on an optical device 220 is readily deployable in merchant checkout devices. Various embodiments of the present invention may induce optical changes in the optical blocking material to implement various features, including, but not limited to, security and authentication features for supply-chain management, selective activation of a subset of available features of an optical device, and so on.

During activation, the Activation System 405 applies an activation energy 410 to the optical device 220. As a result, the optical blocking material 210 may become transparent or sufficiently transparent to allow the content of the read/write surface of the optical device 220 to be read by an optical device player.

FIG. 6 illustrates an exemplary embodiment of an optical device 220 after activation. In FIG. 6, the optical blocking material 210 is no longer visible, having become transparent, and thus allows an optical reader to read the read/write surface of the optical device 220.

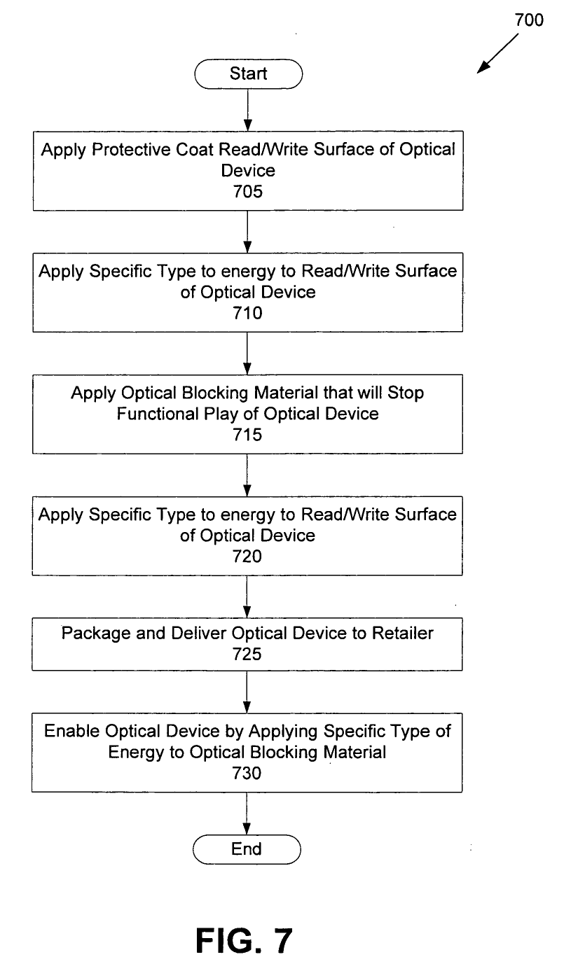

FIG. 7 illustrates a flow diagram of a method 700 for manufacturing and enabling an optical device.

In step 705, the protective layer 205 is applied to optical device 220, and the optical device is spun, forcing the protective layer material to evenly coat the read/write surface of the optical disk.

A first energy applying step 710 then applies a specific type of first energy 305 to the protective layer 205. The first energy 305 is selected and applied at a sufficient intensity and duration to cure the protective layer 205.

In step 715, the optical blocking material 210 is applied to the surface of optical device 220, over at least a portion of the protective layer 205. For example, the optical blocking material 210 may be applied over the entire surface, just the lead-in area 115, or any other portion of the optical device 220, to prevent functional play of the optical device. The optical blocking material 210 is applied in thick enough layers and/or in sufficient concentrations to disable operation of the device 220. The optical blocking material 210 may be applied using various different methods such as, for example, spin-coating, transfer pad printing, or inkjet printing.

A second energy applying step 720 may then be performed by applying a second energy 310 to the optical blocking material 210. The energy selected is applied at a sufficient intensity and duration to cure the optical blocking material 210, without causing optical blocking material 210 to change from a non-transparent into a transparent condition. Alternatively, depending on the type of material constituting the optical blocking material 210, the application of the second energy 310 may not be necessary, for example, when the optical blocking material 210 is a material capable of drying quickly without the application of energy.

The optical device 220 may thereafter be packaged and delivered to a retail store or supply chain location, as indicated by step 725. The portion of the optical blocking material 210 remains in a non-transparent condition at this time, ensuring the optical device 220 is disabled, and therefore, less likely to be stolen or used before being properly purchased at the retail location.

At step 730 the optical device 220 may be activated as needed at the retail location or supply chain location by applying an activation energy 410 to the optical blocking material 210. The activation energy 410 may have a sufficient intensity and duration to make the remaining optical blocking material 210 change from a non-transparent to a transparent condition, to activate the optical device 220.

The first embodiment provides a new production method for applying optical blocking material 210, comprising organic material, to an optical device 220 during the production process. The production method produces a product that meets a manufacturing demand for high-speed, low-cost antitheft-coated optical devices.

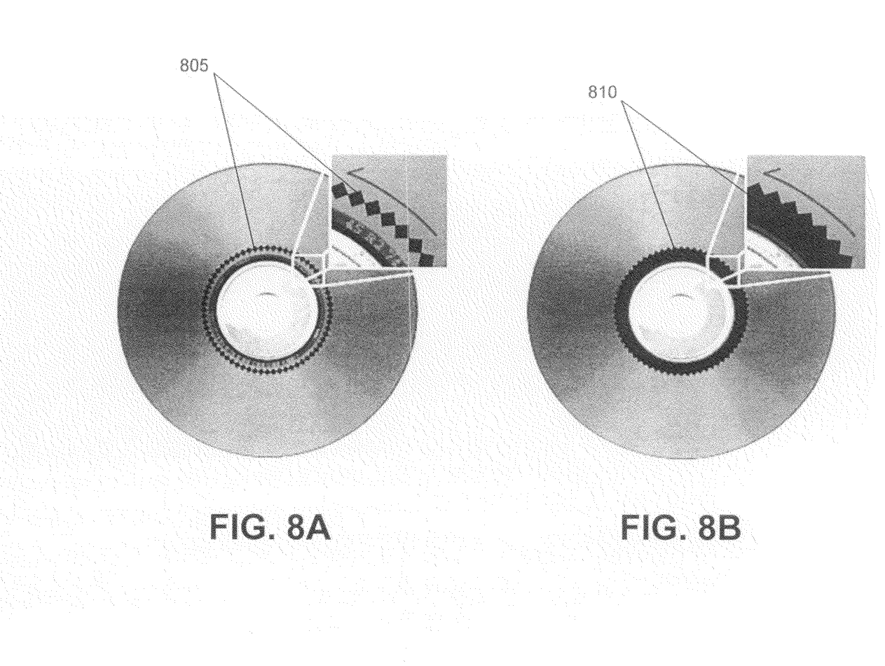

FIGS. 8A and 8B illustrate a second exemplary embodiment of an optical device 220, showing two printed patterns that may be used to make optical device 220 unreadable. Along with reducing the reflective average, specific configurations of printed patterns can be used to cause timing signal changes that make the disc unreadable. In particular, the varying timing signals caused by the printed patterns, increase signal jitter levels above playability levels. Ultimately, activation with a pulsed light source (at a frequency and wavelength that is described previously) may cause the image to disappear.

FIG. 8A illustrates an embodiment where the optical blocking material 210 is applied in a serrated, radial pattern 805 over the lead-in portion of the optical device. FIG. 8B illustrates an embodiment where the optical blocking material 210 is applied in a diamond, radial pattern 810 over the lead-in portion of the optical device. To ensure proper coverage of lead-in area, generally coverage of the lead-in area will extend from between 22 mm to 25 mm. However, depending on the type of optical device 220 employed, the coverage of the lead-in may be in the range of 22.5 mm to 24 mm (for example, for use with Blu-Ray Discs), 22.9 mm to 25 mm (for example, for use with Compact Discs), 22 mm to 24 mm (for example, for use with DVDs), or 14.5-16 mm (for example, for use with UMB Discs). Furthermore, the coverage may extend beyond these ranges depending on the media employed. Alternatively, if the disc contains critical components for playback in other areas not specifically mentioned, other coverage patterns may be employed to ensure proper coverage of these areas.

The use of a radial, serrated edge pattern to obscure the lead-in section improves the readability of media after activation. When the optical blocking material 210 is applied to only a portion of the read/write surface of the optical device 220, the read/write surface can become uneven. After activating the optical blocking material 210, portions of the optical device 220 including the optical blocking material 210, may exhibit a slightly different level of reflection (and refraction) than those without the optical blocking material 210. A sudden change in the level of reflection may cause an optical device reader to experience read type errors for which it cannot quickly compensate. By applying the optical blocking material 210 in a diamond or serrated radial pattern, it may be possible to create a transitional region in which the optical device reader can transition from reading the portion of the disc including (the now transparent) optical blocking material 210 and the portion of the disc without the optical blocking material 210. This transitional region allows the optical device reader to gradually adjust its tracking and compensate for the changing level of reflection on the surface of the optical device 220.

The second exemplary embodiment utilizes a pad printing or pad transfer mechanism to apply the optical blocking material 210 to the optical advice. The benefit of employing a pad transfer mechanism is that the process is inherently high-speed, high-yield and is sufficiently mature in terms of its use in the optical media industry for label decoration. Previously, pad printing has not been used due to the need to employ organic dyes, which damage polycarbonate optical devices. While the process of manufacturing described in FIG. 7 is described with respect to the general application of the optical blocking material 210 via a spin-coating process, the process is equally applicable to pad-transfer printing techniques.

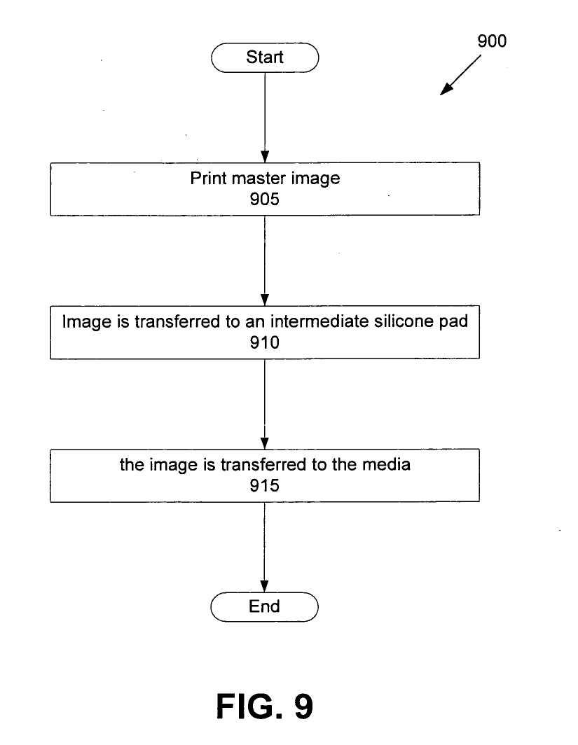

FIG. 9 illustrates a flow chart of a method 900 for applying optical blocking material 210 using pad transfer printing. Method 900 may be substituted into method 700, in place of step 715, to manufacture an optical device using a pad transfer method.

In step 905, a master image is etched or embossed. For example, the image may be a serrated image, as illustrated in FIG. 8A, a diamond pattern, as illustrated in FIG. 8B, or any other image sufficient to prevent the optical device 220 from functioning in a reader, prior to activation.

In step 910, a transfer image is created from a master image. The transfer image is made from the optical blocking material 210. The image is then transferred to an intermediate silicone pad. The silicon pad acts as a stamp to transfer the printed image and apply it to the optical device 220.

In step 915, the pad transfer mechanism transfers the image to the optical device 220. The resulting printing matrix thickness may be controlled via the relief depth of the image on the printing master.

The third embodiment relates to the application of an image onto the read/write surface of the optical device 220 using an inkjet printer in a block or pattern to prevent the optical device 220 from being played. Inkjet printing is a non-contact form of printing. This makes the inkjet system particularly ideal for optical devices, as it reduces the potential of scratching or marring the read surface during the printing process.

Ink jet printing is well established as a printing method for many types of plastic and paper labels used on optical discs. However, inkjet printing has not been employed for optical disc read side printing. Read side printing has suffered from a multitude of problems that have made the cost and risk associated with advertising or text writing unacceptable. For example, laser incident or read side writing did not pass the read side symmetry test, due to the creation of symmetry errors as a results of asymmetrically application of optical blocking inks. Furthermore, the inkjet process commonly employs organic dyes, which as discussed above, have a corrosive effect on polycarbonate.

The third exemplary embodiment overcomes these obstacles in two ways. First, the protective layer 205 discussed above, protects the polycarbonate from the dyes. Secondly, unlike former applications of read-side materials, this embodiment seeks to create, rather than prevent, optical obstructions to the readability of the optical device 220. After activation, the printed material becomes invisible to a laser reader, and therefore does not cause significant read type errors.

This type of functional printing allows text to be written that could warn the consumer that the disc must be taken to the check out counter and activated before it will play. In this case the optical absorption of the text itself is functionally increasing the error rate above the limit that a player can read. After activation the dye photo bleaches and the error rate falls into compliance.

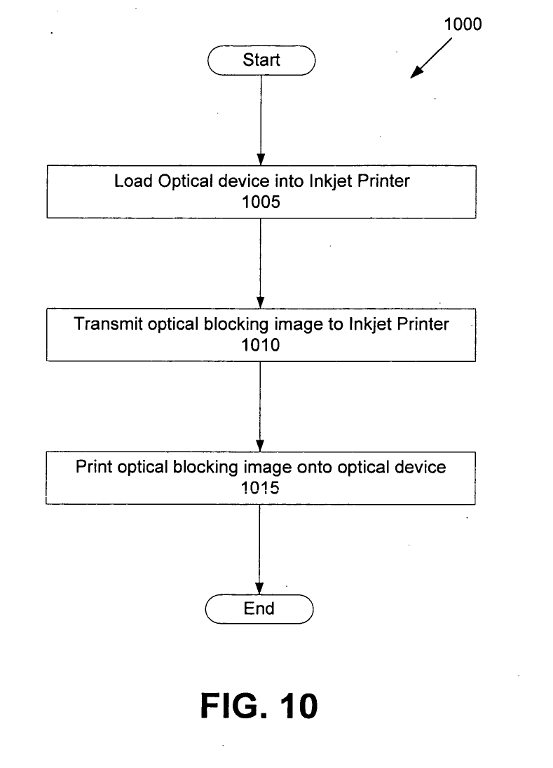

FIG. 10 illustrates a flow chart of an inkjet printing method 1000 for applying optical blocking material 210. Method 1000 can be substituted into method 700, replacing step 725, to manufacture an optical device using an inkjet printing method.

In step 1005, the optical devices 220 may be loaded into a tray or comparable device from the optical device 220 and may be fed into the inkjet printing path.

In step 1010, the image may be transmitted to the inkjet printer. For example, the image may be a serrated image, as illustrated in FIG. 8A, a diamond pattern, as illustrated in FIG. 8B, or any other image sufficient to prevent the optical device 220 from functioning in a reader, prior to activation. Alternatively, the inkjet printer may be pre-programmed with a multitude of selectable patterns. For example, a radial arc may provide sufficient coverage of the lead-in of similar critical area to prevent playback of the disc. In some cases, sufficient coverage of the critical areas may only require covering a radial surface 4-6.5 mm long.

In step 1015, the transmitted image may be applied to the optical device via a non-contact inkjet printing method. For example, the optical device may pass by conveyer under a series of inkjet printing heads. The resulting printing matrix thickness is tightly controlled to produce a smooth and thin surface. The density and/or reflectivity of the optical blocking material will effect the thickness of the optical blocking material, because once activated the optical blocking material can still effect the readability of the disc, as even in the activated state the material may produce some distortion in the light of the reading laser. Accordingly, by controlling the thickness of the optical blocking material it is possible to control or limit the distortion to an acceptable range and thereby ensure readability of the optical device after the optical blocking material is activated.

While embodiments herein are discussed primarily with respect to one-time activation of an optical disc at a point of sale to prevent or thwart theft of the optical device, the invention is not limited thereto. For example, different materials or combinations thereof may be employed to enable multiple state changes for a given energy-sensitive layer, thereby allowing multiple activations and deactivations of an optical device. Multiple activations and deactivations may be particularly important in rental applications, such as movie rentals, where optical devices may need repeated activation and deactivation.

Although embodiments of the invention are discussed primarily with respect to systems and methods for inhibiting theft of an optical device by selectively enabling the optical device 220 after purchase, other uses and features are possible. Various embodiments discussed herein are merely illustrative, and not restrictive, of the invention. For example, energy-sensitive inks in accordance with the present teachings may be employed to thwart copyright infringement.

Various embodiments of the present invention may provide important capabilities and features for merchants of various optical products, such as CDs and DVDs. Such capabilities and features include: simple and reliable one-time activation at the point of sale; extended exposure to direct sunlight will not activate the optical device; activation time of 1 to 3 seconds at the point of sale; activation through product packaging, including product cases; difficult to reverse engineer the activation system; may be cost effectively implemented; and may not degrade the long term performance of the accompanying optical device.

Those skilled in the art may construct optical blocking materials and associated activation equipment to selectively alter the chemistry of the materials to affect transparency without undue experimentation. Conventional systems for inducing changes in material chemistry may be adapted for use with embodiments of the present invention without departing from the scope thereof.

While embodiments herein are discussed primarily with respect to one-time activation of an optical disc at a point of sale to prevent or thwart theft of the optical device, the invention is not limited thereto. For example, different materials or combinations thereof may be employed to enable multiple state changes for a given energy-sensitive layer, thereby allowing multiple activations and deactivations of an optical device. Multiple activations and deactivations may be particularly important in rental applications, such as movie rentals, where optical devices may need repeated activation and deactivation.

Although embodiments of the invention are discussed primarily with respect to systems and methods for inhibiting theft of an optical device by selectively enabling the optical device 220 after purchase, other uses and features are possible. Various embodiments discussed herein are merely illustrative, and not restrictive, of the invention. For example, energy-sensitive inks in accordance with the present teachings may be employed to thwart copyright infringement.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Thus embodiments of the present invention produce and provide systems and methods for selectively enabling and disabling optical devices. Although the present invention has been described in considerable detail with reference to certain embodiments thereof, the invention may be variously embodied without departing from the spirit or scope of the invention. Therefore, the following claims should not be limited to the description of the embodiments contained herein in any way.

1. A method of manufacturing an optical device, comprising:
applying a protective layer over a read-side surface of an optical disc, the protective layer comprising a material that prevents corrosive solvents from damaging the read-side surface of the optical disc;
applying an optical blocking material to at least a portion of the optical device, the optical blocking material including a corrosive solvent capable of damaging the read-side surface of the optical disc.

2. The method of claim 1, wherein the optical blocking material prevents the optical device from being read while the optical blocking material is in an inactivated state.

3. The method of claim 1, wherein the optical disc is comprised of polycarbonate.

4. The method of claim 1, wherein the protective layer polymethyl methacrylate.

5. The method of claim 1, wherein the optical blocking material includes at least one a methylethylkeytone based ink, a glycol ether based ink, or a ethyl acetate based ink.

6. The method of claim 1, wherein the optical blocking material is printed onto the read-side of the optical disc in the shape of a repeating diamond edge.

7. The method of claim 1, wherein the optical blocking material is printed onto the read-side of the optical disc in the shape of a serrated edge.

8. The method of claim 1, wherein the optical blocking material is printed onto the read-side of the optical disc using at least one of an ink-jet printer or a pad-transfer mechanism.

9. The method of claim 1, wherein the optical blocking material is printed in a pattern that makes the read-side of the optical disc unreadable by an optical disc player

10. The method of claim 9, wherein the optical blocking material makes the disc unreadable by the optical disc player be causing the optical disc player to experience symmetry-reading errors.

11. The method of claim 1, wherein the optical blocking material becomes transparent when exposed to an energy source.

12. The method of claim 1, wherein the optical blocking material is an organic dye having a polar chemical character.

13. The method of claim 1, wherein the protective coat has a thickness of less than 3 microns.

14. The method of claim 1, wherein the protective coats cures in less than 2-seconds using an ultraviolet cure cycle.

15. The method of claim 1, wherein the optical blocking material is applied to an entire read-side surface of the optical disc.

16. The method of claim 1, wherein the optical blocking material is only applied to the lead-in area of the optical disc.

17. The method of claim 16, wherein the optical blocking material is applied at a radius in the range of 22.5 millimeters to 24 millimeters.

18. The method of claim 16, wherein the optical blocking material is applied at a radius in the range of 22.9 millimeters to 25 millimeters

19. The method of claim 16, wherein the optical blocking material is applied at a radius in the range of 22 millimeters to 24 millimeters

20. An optical device, comprising:
an optical disc having a read-side surface;
a protective layer covering at least a first portion of a readable area of the read-side surface of the optical disc, the protective layer including a material that prevents corrosive solvents from damaging the read-side surface of the optical device;
an optical blocking material covering at least a second portion of the readable portion of the read-side surface of the optical disc, the optical blocking material including a corrosive solvent capable of corroding the optical disc.

21. The device of claim 20, wherein the optical blocking material is printed in the shape of a repeating diamond edge or a serrated edge.

22. The method of claim 20, wherein the optical blocking material makes the disc unreadable by an optical disc player be causing the optical disc player to experience symmetry reading errors

23. The device of claim 20, wherein the optical blocking material includes a material that becomes transparent when exposed to a pulsed energy source.

24. The device of claim 20, wherein the protective coat has a thickness of less than 3 microns and cures in less than 2-seconds using an ultraviolet cure cycle.

25. The device of claim 20, wherein the optical blocking material is only applied to the lead-in area of the optical disc.
